(19) United States
(12) Patent Application Publication
(10) Pub. No.: US 2007/0147951 A1
(43) Pub. Date: Jun. 28, 2007

(54) Covering element for manual-use articles particularly set for laying of at least one substance, and manual-use article provided with such a covering element

(75) Inventors: Franco Cont, Lugano (CH); Giancarlo Bozzani, Milano (IT)

Correspondence Address: YOUNG & THOMPSON, 745 SOUTH 23RD STREET, 2ND FLOOR, ARLINGTON, VA, 22202, US

(73) Assignee: F.I.L.A.-FABBRICA ITALIANA LAPIS ED AFFINI S.P.A., MILANO (IT)

(21) Appl. No.: 11/498,807

(22) Filed: Aug. 4, 2006

(30) Foreign Application Priority Data
Dec. 22, 2005 (EP) 05425905.6

(51) Int. Cl. B43K 23/12; B43K 23/08

(52) U.S. Cl. 401/243; 401/213

(57) ABSTRACT

A covering element (1) for manual-use articles such as pens, felt-tip pens, correction fluids and the like, includes a case (3) adapted to receive a respective article (2) by insertion. The covering element (1) further includes a coupler to ensure engagement of the covering element (1) with the respective article (2). Advantageously, the covering element is also provided with an abutment element (5) associated with the case (3) to cause shifting of the covering element (1) between a coupled condition and a released condition, by effect of at least one manual action. The abutment element (5) consists of respective abutment surfaces (7, 9) protruding from the case (3) to enable a manual thrust to be exerted on the covering element (1).

The present invention relates to a covering element for manual-use articles, particularly set for laying of at least one fluid substance.

The present invention is also concerned with a manual-use article, such as a pen or similar device for laying a fluid substance, which is provided with the above mentioned covering element.

The invention is adapted for use in any merchandise field and on any manual-use article requiring outer covering for a particularly sensitive and/or delicate portion thereof. With reference to stationery articles for example, the object of the present invention can apply to pens, felt-tip and marking pens, correction fluids, glues and/or similar goods, to protect the tip of same when they are not in use. The present invention can also be widely used in the field of beauty preparations such as lipsticks, mascara, eyeliners and similar products in tubes or sticks. Obviously, the application of the present invention is of such a wide range that it cannot be limited to any specific merchandise field as it spreads over many different sectors.

It is known that covering of particularly sensitive and/or delicate portions of articles such as those mentioned above, usually relies on lids, caps, plugs and/or similar covering elements that are generally applied through screwing and/or mutual engagement by fitting. In particular, when the covering element is put back onto the respective article, at the use portion thereof, the closing element is screwed down or pushed towards the body or the corresponding article through a manual action, until the desired engagement is obtained.

In the same manner as application of the closing element onto the corresponding article takes place, release of the use portion is carried out by unscrewing the covering element or moving it apart until the same is separated from the engaged article. Application and release of the covering element are both executed manually by use of two or more fingers so that full use of the corresponding hand is required.

Where the article is provided with screw-engagement means, for said application and release operations also use of the other hand is required as it must help the first one in imparting a rotation to the article around its longitudinal axis in the opposite direction to the action of the hand active on the covering element. On the contrary, in the presence of means carrying out engagement by fitting, the body of the article is to be pulled in the opposite direction relative to the hand carrying out separation of same.

By virtue of the above, the Applicant has found that while the known covering elements for articles of manual use satisfactorily protect the sensitive and/or delicate portions of the goods to which they are usually applied, they however have some drawbacks and can be improved under different points of view.

In particular, the Applicant has sensed that said covering elements can be improved in relation to disengagement or release of same from the respective articles, and comfort and ease in carrying out this operation.

In fact the Applicant has found that the present articles for manual use compulsorily need use of both hands to cause disengagement of the covering element and/or application of same. While meeting this requirement is usually very simple, it may become particularly difficult when at least one hand of the user is, for any reason, unable to carry out said operations. In other words, the impossibility of use of one hand makes it hard to execute an operation that is apparently easy.

The Applicant has finally sensed that the present techniques for application and/or disengagement of said covering elements can be further facilitated and simplified.

It is an aim of the present invention to obviate the drawbacks found in the known art, by providing a covering element for manual-use articles particularly set for laying of at least one substance, which is of simple and easy application and removal and in addition requires use of one hand alone by the user.

In accordance with the present invention, this aim is achieved by a covering element for articles particularly set for laying of at least one substance, or by a manual-use article provided with said covering element, in accordance with the features described and claimed in the appended claims.

The present invention will be now described with reference to the accompanying drawings showing a preferred, but not exclusive, embodiment of a covering element for articles particularly set for laying of at least one substance, and/or of a manual-use article provided with said covering element, in accordance with the present invention. In the drawings:

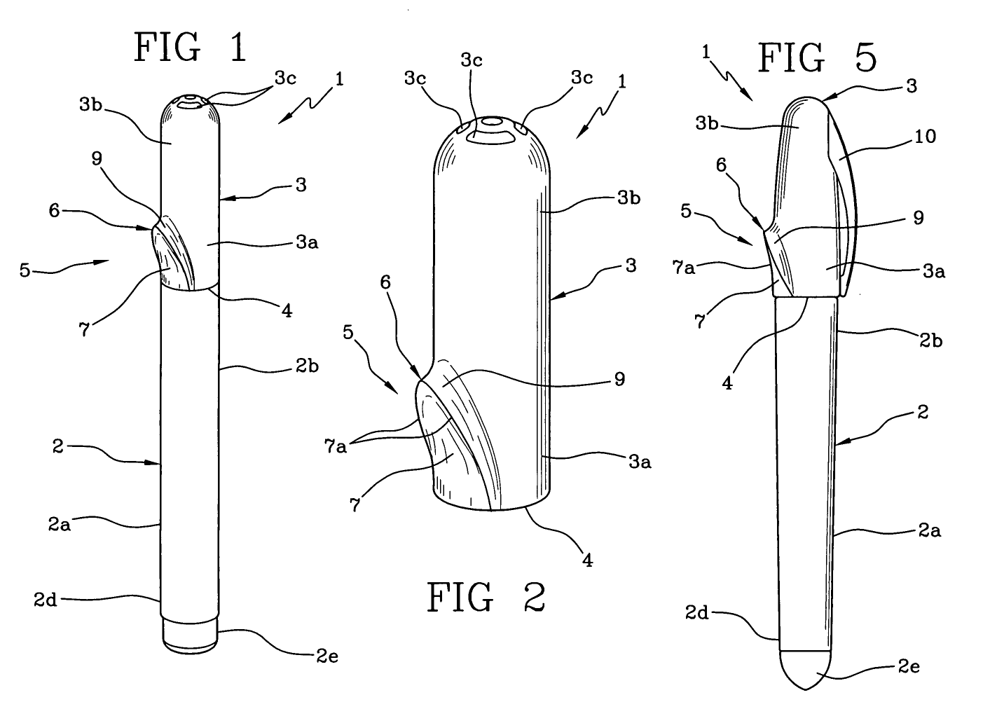

FIG. 1 is a perspective view of a covering element applied to a respective article for manual use, in accordance with the present invention;

FIG. 2 is a perspective view of the element seen in the preceding figure and herein represented alone;

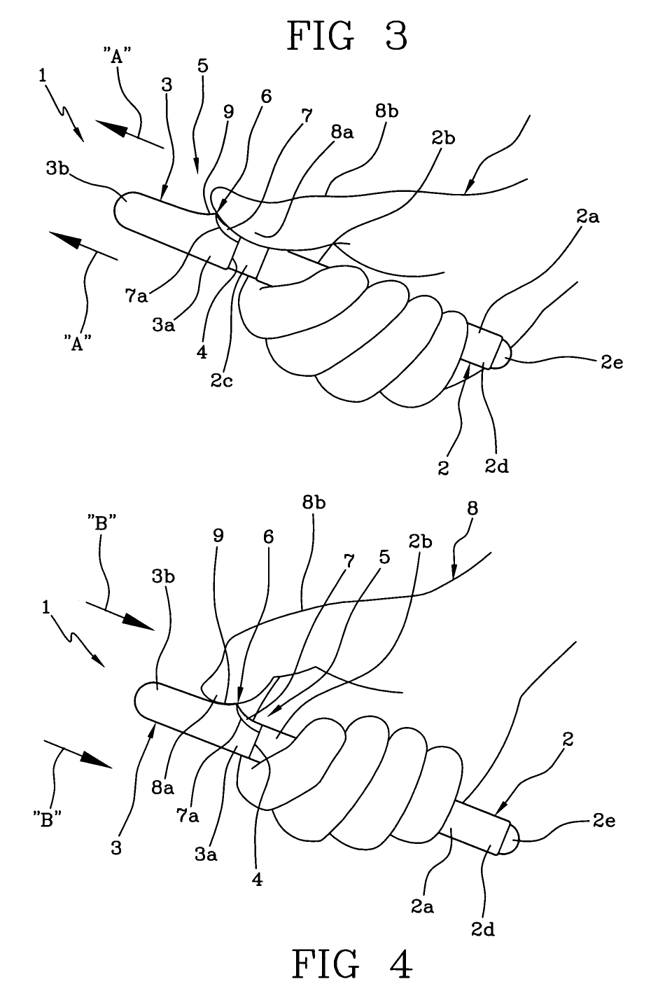

FIG. 3 is a diagrammatic view showing release of the covering element seen in the preceding figures, carried out by a manual thrust action;

FIG. 4 is a diagrammatic view of the coupling operation between the covering element and the respective article, carried out by a manual thrust action contrary to the one causing release;

FIG. 5 is an elevation view of a further embodiment of the covering element in accordance with the present invention.

With reference to the drawings, a covering element for manual-use articles particularly set for laying of at least one substance, in accordance with the present invention, has been generally identified by reference numeral 1.

In particular, the covering element 1 is adapted to be employed on any type of article 2 (FIGS. 1 and 3 to 5) for manual use that can be found in different merchandise fields such as the field of stationery articles, beauty preparations, articles for medical treatments, body treatments and so on. In other words, the covering element 1 can find application in any merchandise sector where there is the presence of articles 2 to be at least partly covered and protected.

Referring particularly to FIGS. 1 and 3 to 5, the article 2 herein shown by way of example and therefore not for purposes of limitation of the present invention, preferably is a cylindrical stationery article 2 such as a pen, a felt-tip pen, a correction fluid, a glue and/or the like.

Still referring to FIGS. 1 and 3 to 5, article 2 comprises a body 2a of substantially elongated shape having at least one use portion 2c (partly seen in FIG. 3) at one end 2b thereof, which portion is designed to be at least partly covered with said covering element 1 in a non-use condition. On the opposite side from the first end 2b, article 2 has a second end 2d of a substantially tapering and rounded conformation, the section of which progressively decreases so that it terminates with a portion 2e that is able to receive in engagement by interference fit, the above mentioned covering element 1 during use of the article itself.

Still with reference to the accompanying figures, the covering element 1 comprises at least one hollow case 3 of substantially elongated and tapering shape. In detail, the hollow case 3 has a first end 3a provided with a suitable access opening 4 to receive the use portion 2c of article 2 when the latter is not used and a second substantially rounded end 3b, opposite to the first one 3a that, in case of need, is provided with suitable aeration ports 3c (FIGS. 1, 2 and 5).

The covering element 1 further comprises coupling means (not shown as it is known) associated with the hollow case 3 to steadily engage the covering element 1 with the respective article 2. Preferably, the coupling means has at least one snap-hooking system co-operating with respective coupling elements (not shown) disposed on the first end 2b of article 2, in such a manner as to counteract possible detachment of the covering element 1.

Advantageously, the covering element 1 comprises abutment means 5 associated with the hollow case 3 to cause shifting of the covering element, following at least one manual action by a user, between a coupled condition (FIGS. 1, 4 and 5) at which it engages the respective article 2 and a released condition (FIGS. 2 and 3) at which it is separated therefrom.

As shown in the accompanying drawings, the abutment means 5 contemplates the presence of at least one protrusion 6 jutting out externally of the hollow case 3, transversely of the longitudinal extension of same. In particular, the protrusion 6 has a first abutment surface 7 facing the article 2 when the covering element 1 is disposed in the coupled condition (FIGS. 1, 4 and 5). The first abutment surface 7 appears on the opposite side with respect to case 3, preferably following an inclined extension relative to the longitudinal extension of the covering element 1. More specifically, the first abutment surface 7 radially moves away from the hollow case 3 starting from the first end 3a of the latter towards the second end 3b.

Referring again to the accompanying drawings, the first abutment surface 7 has an arched extension. Preferably, said first abutment surface 7 is substantially concave and defines a recessed central region and raised peripheral regions, respectively.

As shown in FIG. 2, the first abutment surface 7 has a substantially rounded peripheral edge 7a the outline of which has an at least partly elliptical conformation. The shape of the first abutment surface 7 advantageously matches that of the fingertip 8a of one finger, preferably the thumb 8b, of one hand 8 so that it is adapted to receive the corresponding finger in ergonomic engagement.

The protrusion 6 further has a second abutment surface 9 extending between the first abutment surface 7 and the hollow case 2, transversely of the latter and of the first abutment surface 7. In detail, the second abutment surface 9 extends starting from the peripheral edge 7a of the first abutment surface 7 to joint the outer surface of case 3. In other words, the second abutment surface 9 peripherally extends around the first abutment surface 7 and partly surrounds it.

The second abutment surface 9 too has an arched extension, and is preferably concave. Advantageously, the second abutment surface 9 is connected with the hollow case 3 without a break, so that no line between the second abutment surface 9 and the outer surface of the hollow case 3 can be felt by the touch.

In accordance with a further embodiment of the present invention shown in FIG. 5, the covering element 1 comprises at least one hooking tailpiece 10 extending from the hollow case 3 for engagement of the covering element 1 with at least one substantially flat portion of a garment, such as a pocket, a loop, and the like.

As shown in FIG. 5 the hooking tailpiece 10 extends from the hollow case 3 on the opposite side relative to protrusion 6 and juts out from the second end 3b of the hollow case 3 towards the first end 3a of the latter terminating at a position close to the access opening 4.

Operation of the present invention described above mainly as regards structure, is as follows.

As shown in FIG. 3, when article 2 provided with the above mentioned covering element 1 is to be used, it can be grasped with one hand 8 so that all the fingers, apart from the thumb 8b, surround the body 2a of article 2 and are closed around it. Advantageously, in this position the thumb 8b naturally rests on the protrusion 6 of case 3 of the covering element 1. Consequently, the thumb 8b lays on the first abutment surface 7 the particular shape of which ensures the best relationship of mutual adaptation between the user's finger and the covering element 1.

Following a suitable thrust action aiming at moving the covering element 1 away from article 2 (identified in FIG. 3 by the direction arrows “A”), said covering element 1 translates along the longitudinal axis of article 2 moving apart from the use portion 2c of the latter.

Obviously, the shape of the first abutment surface 7 allows a thrust action of a sufficient intensity to be carried out by the thumb 8b so as to overcome the resistance exerted by the coupling means of the covering element 1 and cause shifting of the covering element itself 1 from the coupled condition to the released condition.

Separation of the covering element 1 is made easier by the user's fingers surrounding the body 2a of said article 2 and retaining it.

On the contrary, with reference to FIG. 4, shifting of the covering element 1 from the released condition to the coupled condition is caused by a further thrust action exerted on the covering element 1 in the opposite direction with respect to the release direction (direction arrows “B” in FIG. 4). Under this situation, the user's hand 8 is maintained to a closed condition around article 2, while the thumb 2b rides over the peripheral edge 7a and bears on the second abutment surface 9 to push the latter towards the element 2. The covering element 1 moves close to the element 2 until the coupling means causes a steady engagement between the covering element 1 and element 2.

With reference to the embodiment shown in FIG. 5, operation of the covering element is unchanged. However, due to the presence of the hooking tailpiece 10, application of the covering element 1 coupled with article 2, to a user's garment is allowed.

The present invention solves the problems found in the known art and reaches the intended purposes.

First of all, due to the particular conformation of the abutment means of the above described covering element, the operation for releasing it from the respective article is facilitated.

In addition, said abutment means can also be used to simplify the coupling operation between the covering element and the corresponding article.

In more detail, the operation for releasing and/or coupling the covering element can be advantageously carried out through use of one hand alone, by a simple and quick movement. In other words, the closing element as designed allows separation from the use portion of the respective article without the aid of the other hand, so that any user physically unable to employ both hands is facilitated.

1. A covering element (1) for manual-use articles (2) particularly set for laying of at least one substance, said covering element (1) comprising:
at least one hollow case (3) provided with at least one access opening (4) to receive at least one respective use portion (2c) of a manual-use article (2) to be inserted therein;
coupling means associated with said case (3) to ensure engagement of said covering element (1) with the respective article (2),
characterized in that it further comprises abutment means (5) associated with said case (3) to cause shifting of said covering element (1), by effect of at least one manual action, between a coupled condition at which it engages the respective article (2) and a released condition at which it is separated from said article (2).

2. The element as claimed in claim 1, wherein said abutment means (5) comprises at least one protrusion (6) jutting out externally of said case (3), transversely of the longitudinal extension of the covering element (1).

3. The element as claimed in claim 2, wherein said protrusion (6) has a first abutment surface (7) facing said article (2) when said covering element (1) is disposed in the coupled condition.

4. The element as claimed in claim 3, wherein said first abutment surface (7) is inclined to said case (3), said first abutment surface (7) moving radially away from said case (3), starting from said access opening (4).

5. The element as claimed in claim 3, wherein said first abutment surface (7) has a substantially arched extension.

6. The element as claimed in claim 3, wherein said first abutment surface (7) is concave.

7. The element as claimed in claim 3, wherein said first abutment surface (7) has an at least partly rounded peripheral edge (7a).

8. The element as claimed in claim 7, wherein said peripheral edge (7a) of said first abutment surface (7) has an at least partly elliptical outline.

9. The element as claimed in claim 3, wherein the shape of said first abutment surface (7) substantially matches one fingertip (8a) of a finger of a user's hand (8).

10. The element as claimed in claim 3, wherein the shape of said first abutment surface (7) substantially matches the fingertip (8a) of a thumb (8b).

11. The element as claimed in claim 3, wherein said protrusion (6) has a second abutment surface (9) extending between said first abutment surface (7) and said case (3), transversely with respect to the latter and to said first abutment surface (7).

12. The element as claimed in claim 11, wherein said second abutment surface (9) peripherally extends around said first abutment surface (7).

13. The element as claimed in claim 11, wherein said second abutment surface (9) has an arched extension.

14. The element as claimed in claim 11, wherein said second abutment surface (9) is concave.

15. The element as claimed in claim 11, wherein said second abutment surface (9) is joined to said case (3).

16. The element as claimed in claim 1, further comprising at least one hooking tailpiece (10) extending from said case (3) for engagement of said covering element (1) with at least one substantially flat portion of a garment.

17. The element as claimed in claim 16, wherein said hooking tailpiece (10) extends from said case (3) on the opposite side relative to said protrusion (6).

18. An article (2) for manual use comprising a body (2a) having at least one use portion (2c) than can be externally covered, said article further comprising at least one covering element (1) as claimed in claim 1.

19. The article as claimed in claim 18, wherein said article is a pen or similar stationery article.

20. The element as claimed in claim 4, wherein said first abutment surface (7) has a substantially arched extension.
